(19) United States
(12) Patent Application Publication
(10) Pub. No.: US 2026/0302876 A1
(43) Pub. Date: Oct. 1, 2026

(54) ELECTRIC MOTOR ARRANGEMENT WITH ELASTOMERIC STATOR DECOUPLING

(71) Applicant: Vibracoustic SE, Weinheim (DE)

(72) Inventors: Niklas Müller, Ihringen (DE); Markus Dürre, Neuenburg am Rhein (DE); Joschka Gutmann, Staufen Im Breisgau (DE); Leon Müller, Bantzenheim (FR)

(21) Appl. No.: 19/447,115

(22) Filed: Jan. 13, 2026

(30) Foreign Application Priority Data
Jan. 13, 2025 (DE) 10 2025 100 971.6

(51) Int. Cl. H02K 5/24; H02K 1/18

(52) U.S. Cl. CPC H02K 5/24; H02K 1/185

(57) ABSTRACT

The proposal is for an electric motor assembly (2) having an elastomeric support (300) for the elastomeric decoupling of a stator element (200).

Electric motors comprise a housing, a stator and a rotor. As a rotating part, the rotor can be the source of noise, vibration and oscillations associated with running. The rotor transmits these oscillations to the stator, which in turn transmits them to the housing. However, known rotors have inadequate NVH properties (noise, vibration, harshness) in respect of their fixing to the housing. Hitherto, this problem has been counteracted by means of NVH covers in order to enclose the noise, vibration and oscillations associated with running. However, such covers take up a lot of installation space.

As yet, there is no known satisfactory solution for effectively avoiding or reducing the transmission of oscillations, in particular torsional vibrations, from the stator to the housing.

The problem to be solved by the invention is therefore that of making a corresponding improvement to the prior art.

The problem is solved by means of the features of claim 1. Refinements are the subject matter of the dependent claims and of the rest of the disclosure.

According to the invention, the proposal is for an electric motor assembly comprising
a central longitudinal axis, which passes through the electric motor rotor assembly,
a housing,
a stator element, which is fixed on the housing by means of a fixing,
wherein the fixing comprises at least one elastomeric support for elastomeric decoupling.

The stator element is elastomerically supported by means of the at least one elastomeric support. The housing and the stator element are now elastomerically decoupled from one another. The invention effects a division of the transfer path from the stator element to the housing by means of the elastomeric support. By means of the elasticity of the elastomer of the support combined with the material damping of the elastomer of the support, it is possible to reduce the hitherto unwanted oscillations. An improvement in the NVH behavior is also achieved. It is possible to dispense with the NVH covers used hitherto.

The housing can be a motor housing. The stator element can be a stator or a stator carrier. The stator carrier can be a sleeve. The fixing is the only fixing between the housing and the stator element. The electric motor assembly is free from any metallic contact between the housing and the stator element. The stator element is provided with exclusively elastomeric support on the housing. The elastomeric support can preferably have a decoupling function in all three directions of translation. The elastomeric support can preferably have a decoupling function in all three directions of rotation. It is conceivable for the elastomeric support to be fixed on the housing and to bear against the stator element while providing elastomeric support. It is conceivable for the elastomeric support to be fixed on the stator element and to bear against the housing while providing elastomeric support. Where there is a plurality of elastomeric supports, a combination thereof is also conceivable. It is conceivable for the housing and/or the stator element and/or the at least one elastomeric support to be connected by axial assembly to form the electric motor assembly. The central longitudinal axis extends centrally through the stator element. The stator element can be intersected by a cross-sectional plane. The cross-sectional plane can divide one axial side of the stator element from the other axial side of the stator element.

The elastomeric support can comprise an elastomer element, the elastomer element preferably is in contact in the circumferential direction and/or in the axial direction and/or in the radial direction, the elastomeric support preferably further comprising a carrier element. The elastomer element bears against the housing or the stator element and is fixed on the other of the housing and the stator element. The bearing contact serves to provide decoupling in the respective spatial direction. The carrier element carries the elastomer element. It is conceivable for the carrier element to be a single elastomer element. This enables the elastomeric support to be pre-produced as a self-contained unit. The carrier element can be a separate part from the housing and the stator element. If no carrier element is provided, the elastomer element can be fixed directly to the housing or stator element. In this case, it is possible to dispense with an additional carrier element. The elastomeric support can comprise a single elastomer element, wherein there can be advantageous functional integration into the single elastomer element. The elastomer element of the elastomeric support can be in one piece. This makes it easier to produce and improves the damping behavior.

The elastomer element can be materially joined to its carrier element and/or the housing and/or the stator element, wherein this represents a lifetime joint. This can be accomplished by means of vulcanization, for example. The elastomer element can be connected and/or press-fitted to its carrier element and/or the housing and/or the stator element without a material joint. Location between the housing and the stator element can render a material joint superfluous and can ensure permanent positioning of the elastomer element.

The elastomeric support can comprise at least one elastomeric axial support and/or at least one elastomeric torsional support and/or at least one elastomeric radial support, wherein the axial support/s and/or the torsional support/s and/or the radial support/s is/are preferably formed by different portions of the (a single) elastomer element. This represents a preferred functional integration into the single elastomer element.

The elastomeric support can form a press-fit joint or a material joint or a screwed joint for self-fixing. This self-fixing can be to the housing or to the stator element. It is conceivable that the joint is made by means of the elastomer element and/or by means of the carrier element. The self-fixing (press-fit joint and screwed joint and material joint by means of an adhesion promoter) can serve to enable production separately from the housing or the stator element. However, production directly on the housing or on the stator element by means of vulcanization (as an example of a material joint) is also conceivable.

The electric motor assembly can comprise an elastomeric ring seal, the ring seal preferably being continuous in the circumferential direction. The ring seal can form a seal between the housing and the stator element and/or can fluidically separate two axial regions from one another. The ring seal can be subjected to pressure in the radial direction and/or the axial direction, preferably being squeezed between and/or by the housing and/or the stator element and/or the carrier element. The ring seal can be formed by the elastomer element. In this case, it is an integral component of the elastomer element. Alternatively, the ring seal can be a separate part from the elastomer element. This provides greater freedom in the design of the elastomeric support. The ring seal offers effective sealing with respect to the circulating oil, promoting durability and reliable operation, especially of electric motors. The stator element can have a ring seal at each of the two axial ends.

The elastomeric support can be arranged to provide elastomeric decoupling at one end of the stator element and/or can be arranged in an end-face region of the length of the stator element in order to provide elastomeric decoupling, the region of the length preferably corresponding to at most 20% of the total axial length of the stator element, as a further preference at most 10%. This enables the elastomeric support to be located in such a way that it can ensure satisfactory decoupling. Location at or close to an end face allows high cardanic stiffness and also ensures the introduction of force into a robust region of the housing. The elastomeric support can bear elastomerically against a housing flange or can itself be fixed there. Another elastomeric support can provide elastomeric decoupling in exactly the same way or in a different way to that described at the other end face of the stator element or in the other end-face region of the length of the stator element.

The stator element can be supported axially at both ends by means of elastomeric supports. It is conceivable for at least one or at most one elastomeric support and/or at least one or at most one pin arrangement to be located axially at one end of the stator element and for at least one or at most one elastomeric support and/or at least one or at most one pin arrangement to be located axially at the other end of the stator element. The supports arranged axially at both ends can be identical or different. It is conceivable for a decoupling ring and/or at least one decoupling pin or a pin arrangement to be provided at one end of the stator element and for a decoupling ring and/or at least one decoupling pin or a pin arrangement to be provided axially at the other end of the stator element. It is conceivable for the support or supports to provide decoupling in the radial direction axially at one end and axially at the other end. It is conceivable for only the support/supports on one of the two axial sides of the stator element to provide decoupling in the torsional direction and the axial direction. As a result, the support/supports on the other axial side can be of smaller construction.

The above general disclosure can be made more specific in terms of design. According to a first alternative, a decoupling ring can be provided for elastomeric decoupling and, according to a second alternative, a decoupling pin can be provided, wherein a plurality of decoupling pins can form a pin arrangement. As described in detail below in respect of each of the two alternatives, the special technical features of each alternative achieve the same technical effect and solve the same technical problem.

The elastomeric support can be a decoupling ring, preferably comprising a carrier ring and an elastomer ring, as a further preference comprising only these parts. The carrier ring can be the carrier element. The elastomer ring can be the elastomer element. The decoupling ring and/or the carrier ring and/or the elastomer ring can be continuous in the circumferential direction. This enables uniform decoupling. The carrier ring can be a separate part from the housing and the stator element. This can be exploited in order to produce the housing or stator element separately.

It is conceivable that the decoupling ring is formed only by the elastomer ring. The decoupling ring can then be formed without a carrier ring. This reduces the number of components and the installation space requirement.

In the case of the decoupling ring, it is conceivable that the carrier ring has an L-shaped profile or a Z-shaped profile in longitudinal section, and the legs of the profile preferably enclose right angles. As a result, the legs of the carrier ring can be used for support on the housing or stator element and/or for backing the elastomer ring in order to provide support. The elastomer ring can be arranged on at least one leg.

The decoupling ring can form an elastomeric tooth system with teeth, which engages in a form-fitting manner in a corresponding mating contour, the teeth preferably being trapezoidal when viewed in the radial direction and/or the mating contour being trapezoidal when viewed in the radial direction. This form-fitting engagement prevents slipping. The mating contour can be formed by the housing or stator element. The mating contour can be formed by end-face recesses. This allows a radially compact construction and facilitates axial assembly. The mating contour can comprise at least one axial surface and/or one radial surface. The mating contour can be referred to as an annular mating contour. The tooth system can be formed in the direction of assembly. The tooth system is an advantageous option for achieving decoupling in various spatial directions. It is conceivable for the tooth system/teeth to bear in the circumferential direction and/or in the axial direction and/or in the radial direction and to decouple in the corresponding direction(s). Preferably exclusively in one of these directions, as a further preference exclusively in the circumferential direction. Each tooth can have a tooth head with a tooth surface and/or two tooth flanks. If the tooth system/teeth bears/bear (exclusively) in the circumferential direction, e.g. by means of elastomeric radial contact surfaces, they can bear on (a) mating radial contact surface(s), e.g. formed by the housing or stator element.

In the case of the decoupling ring, it is conceivable that the teeth each have a free head surface on a tooth head. The head surface can delimit a gap. The head surface can have an axial clearance with respect to the mating contour. The free head surface between the tooth system and the mating contour is used to achieve a high cardanic stiffness.

In the case of the decoupling ring, it is conceivable that the trapezoidal shape of the teeth and/or mating contour tapers in the direction of a transverse center plane. This prevents material-damaging tensile stress under axial loading. The tooth flanks can bear against the mating contour.

In the case of the decoupling ring, it is conceivable that the teeth each project in the radial direction into the interior of the stator element, preferably by an inward projection distance of from 1 mm to 10 mm. This serves to ensure secure contact and prevents them from slipping off.

In the case of the decoupling ring, it is conceivable that the teeth each comprise a tooth core, which is formed by the housing or the stator element or the carrier ring. As a result, the tooth is of stable design and can absorb and transmit forces in an optimum manner. Moreover, the life of the tooth is extended. The tooth core can be formed by virtue of the fact that the housing or the stator element or the carrier ring projects by means of a protrusion into the elastomer ring.

In the case of the decoupling ring, it is conceivable that the axial support is formed by an elastomeric contact end face of the elastomer ring. The contact end face can bear on the housing or the stator element or the stator carrier end face thereof. The contact end face promotes axial stiffness. The contact end face can be different from the head surface or identical therewith. Separation helps with more targeted structural adaptation of the respective surface, while integration helps with functional integration and saving of installation space.

In the case of the decoupling ring, it is conceivable that the elastomeric contact end face forms contact end-face recesses. The contact end-face recesses can be arcuate. They are used for adjusting the progression and the axial characteristic. The contact end-face recesses have an axial clearance with respect to the bearing surface of the housing or stator element.

In the case of the decoupling ring, it is conceivable that the torsional support is formed by elastomeric radial contact surfaces of the elastomer ring. The radial contact surfaces can bear on the housing or the stator element in the circumferential direction. The radial contact surfaces can be formed by the tooth flanks. The radial contact surfaces promote torsional stiffness. The radial contact surfaces can be different from the tooth flanks or identical therewith. Separation helps with more targeted structural adaptation of the respective surface, while integration helps with functional integration and saving of installation space.

In the case of the decoupling ring, it is conceivable that the radial support is formed by an elastomeric circumferential contact surface of the elastomer ring. The circumferential contact surface can bear on the housing or the stator element. The circumferential contact surface can be an outer or inner circumferential surface. The circumferential contact surface promotes radial stiffness.

In the case of the decoupling ring, it is conceivable that the elastomer ring forms bearing pads and/or passage portions in the circumferential direction. This configuration is used for the adjustment of stiffness levels in the axial and/or radial directions. The bearing pads can be arranged adjacent to one another in the circumferential direction. The passage portions can be arranged adjacent to one another. The bearing pads and passage portions can be arranged alternately in the circumferential direction.

The bearing pads can form the axial supports and/or the torsional supports and/or the radial supports. The bearing pads can bear on the housing or the stator element. The axial supports can bear on one end face of the housing or stator element, for example. The radial supports can bear on one circumferential surface of the housing or stator element, for example. The axial supports promote axial stiffness. The radial supports promote radial stiffness. Each bearing pad can be formed by an axial support and a radial support. This configuration is used for the adjustment of stiffness levels in the axial and/or radial directions.

The passage portions can form a clearance with respect to the housing and/or stator element, preferably with the circumferential surface and/or end face of the housing and/or stator element. The passage portions can be axial passages and/or radial passages. Each passage portion can be formed by an axial passage and a radial passage. This configuration is used for the adjustment of stiffness levels in the axial and/or radial directions. The passage portions can be delimited by the elastomer body and/or carrier element and/or housing and/or stator element. It is thereby possible to perform a design adaptation.

In the case of the decoupling ring, it is conceivable that the ring seal is formed by the elastomer ring. The one-piece design reduces a number of components and leads to a compact construction. The ring seal can extend in the direction of the transverse center plane. This serves for an axially compact design. The ring seal can be squeezed in the radial direction by a sleeve. This serves to provide high leaktightness.

It is conceivable that the decoupling ring is fixed on an outer circumferential side of the stator element. The fixing can be a press-fit joint, preferably by means of the carrier ring. The elastomer ring can bear elastically on the housing.

It is conceivable that the decoupling ring is fixed on the housing. The fixing can be a press-fit joint, preferably by means of the carrier ring. The elastomer ring can bear elastically on the stator element, preferably on the outer circumferential surface of the stator element and/or on the stator carrier end face and/or on stator carrier radial surfaces. The stator carrier radial surfaces can be formed by the mating contour.

The elastomeric support can be a decoupling pin, preferably comprising a carrier pin and an elastomer cap, as a further preference comprising only these parts. The carrier pin can be the carrier element. The elastomer cap can be the elastomer element.

This enables point-type decoupling. The carrier pin can be a separate part from the housing and the stator element. This can be exploited in order to produce the housing or stator element separately. Despite the design-geometric specifications relating to the housing and/or stator element, the decoupling pin is simple to arrange—it is variable in its position. The electric motor assembly can comprise a plurality of decoupling pins. The decoupling pin has a pin longitudinal axis. It extends through the decoupling pin in the longitudinal direction. The pin longitudinal axis can be parallel to the central longitudinal axis.

In the case of the decoupling pin, it is conceivable that the carrier pin carries the elastomer cap. The elastomer cap can be fixed on the carrier pin by material bonding (vulcanized on or by means of an adhesion promoter) or press-fitted thereon. The carrier pin can form a backing structure for the elastomer cap and thus form a reliable abutment. The carrier pin can be of one-piece design. This simplifies production and promotes durability.

In the case of the decoupling pin, it is conceivable that the carrier pin forms a fixing region and a carrier region. The fixing region fixes the carrier pin on the housing or on the stator element. The fixing region can form a thread. The carrier pin can thereby be screwed reversibly in a simple manner into a mating thread in the housing or stator element. The fixing region can form a press-fit surface. The carrier pin can thereby be pressed in a simple manner into the housing or stator element. The carrier region carries the elastomer cap.

In the case of the decoupling pin, it is conceivable that the carrier region forms a fixing stop. The fixing stop can define a mounting position and/or can face the carrier region. The fixing stop can bear on the housing or the stator element. It is conceivable that the carrier region has a larger diameter than the fixing region. As a result, the elastomer cap can also be of larger construction and/or the fixing stop can be produced.

In the case of the decoupling pin, it is conceivable that the elastomer cap has a cylindrical portion and/or an end-face portion and engages in a corresponding mating contour, preferably in a form-locking manner, at least in some section or sections. Such an elastomer cap can provide insulation at the circumference and/or axially in an advantageous manner. The decoupling pin can engage in the axial direction in the mating contour. This simplifies assembly. The mating contour can be referred to as a mating pin contour.

In the case of the decoupling pin, it is conceivable that the cylindrical portion can be a hollow-cylindrical portion and/or can be backed by the carrier region. The cylindrical portion can be continuous in the circumferential direction (in relation to the pin longitudinal axis). The decoupling pin thus has a continuous rubber sheath around the circumference. The elastomer cap can bear partially or fully on the mating contour at the circumference. The elastomer cap can bear partially or fully on the mating contour at the end face. This enables a decoupling pin to provide decoupling in the axial, radial and circumferential directions.

In the case of the decoupling pin, it is conceivable that the end-face portion is disk-shaped and/or is backed by the carrier region. The elastomer cap can bear partially or fully on the mating contour axially.

In the case of the decoupling pin, it is conceivable that the elastomer cap forms contouring on the outer circumference and/or contouring on the end face. It is thereby possible to adjust a stiffness in the corresponding spatial direction.

It is conceivable that the decoupling pin and/or the carrier pin and/or the carrier region and/or the fixing region and/or the elastomer cap are/is rotationally symmetrical with respect to their/its own pin longitudinal axis or are/is a solid of revolution. Configuration as a solid of revolution simplifies production and assembly since this can take place without alignment.

In the case of the decoupling pin, it is conceivable that the elastomer cap has a 2-fold rotational symmetry (in relation to the pin longitudinal axis) (n=2). The elastomer cap can have two regions of a first material thickness, which may be situated diametrically opposite one another in relation to the pin longitudinal axis, and two further regions of a second material thickness, which may lie diametrically opposite one another in relation to the pin longitudinal axis, wherein the first material thickness is greater than the second material thickness. By virtue of this fact, the elastomer pad of the decoupling pin can be thicker in one spatial direction, e.g. in the radial direction (in relation to the central longitudinal axis) than in another spatial direction, e.g. in the circumferential direction (in relation to the central longitudinal axis). It is thereby possible to adjust a stiffness in the corresponding spatial direction.

In the case of the decoupling pin, it is conceivable that the elastomer cap is oval in cross section, and/or the elastomer cap has a constant material thickness in at least one first angular window, which is preferably lies in the circumferential direction or radial direction, and/or the elastomer cap has a material thickness in the radial direction which is greater than a/the material thickness in the circumferential direction, or vice versa. It is thereby possible to adjust a stiffness in the corresponding spatial direction. It is conceivable that the elastomer cap is oval in cross section, and/or the elastomer cap has a constant material thickness in two first angular windows, which preferably lie in the circumferential direction or radial direction, and/or the elastomer cap has a material thickness in the radial direction which is greater than a/the material thickness in the circumferential direction, or vice versa. It is thereby possible to adjust a stiffness in the corresponding spatial directions.

In the case of the decoupling pin, it is conceivable that the outer circumferential surface of the carrier pin, preferably of the carrier region, lies on an imaginary first circle and the outer circumferential surface of the elastomer cap lies on an imaginary second circle, preferably at least in some section or sections, e.g. fully within the/a first angular window, wherein the two imaginary circles are concentric circles. It is thereby possible to produce a constant material thickness in this region. By means of the concentric circles, a linear pressure on the elastomer cap can be converted into a surface pressure, increasing the life of the elastomer cap.

The first angular window/s can lie in the circumferential direction. The first angular window/s can have a width of between 5° and 45°. Two first angular windows can lie diametrically opposite one another in relation to the pin longitudinal axis. The angular window/s can have the corresponding pin longitudinal axis as a center.

In the case of the decoupling pin, it is conceivable that the mating contour is rotationally symmetrical in relation to the corresponding pin longitudinal axis or is a solid of revolution. The solid of revolution promotes uniform stiffness in the corresponding spatial directions. The rotational symmetry can be set in such a way that different stiffnesses are obtained in different spatial directions, e.g. by virtue of different distances from the elastomer element. It is conceivable that the mating contour is oval in cross section. It is thereby possible to adjust a stiffness in the corresponding spatial direction. The long transverse extent of the oval mating contour can extend in the radial direction or the circumferential direction (in each case in relation to the central longitudinal axis). The short transverse extent of the oval mating contour can extend in the direction other than the radial direction and the circumferential direction (in each case in relation to the central longitudinal axis). It is thereby possible to set a softer or harder torsion characteristic and to influence the progression. The rotational symmetry (in relation to the pin longitudinal axis) can be 2-fold (n=2).

In the case of the decoupling pin, it is conceivable that the mating contour, together with the elastomer cap, delimits at least one displacement space. Elastomer from the elastomer cap can be displaced into the displacement space when acted upon by a load. It is thereby possible to set a softer or harder torsion characteristic and to influence the progression. Two displacement spaces situated diametrically opposite one another in relation to the pin longitudinal axis are conceivable. Two displacement spaces situated diametrically opposite one another along the radial direction in relation to the pin longitudinal axis are conceivable. This creates displacement spaces in the centrifugal direction.

In the case of the decoupling pin, it is conceivable that the elastomer cap is in contact in the circumferential direction and delimits at least one/the displacement space in the radial direction, or vice versa. The elastomer cap can bear on the mating contour, at least in some section or sections, preferably at least in two regions located diametrically opposite in relation to the pin longitudinal axis. The circumferential direction and the radial direction may relate to the central longitudinal axis. The elastomer cap can bear on the mating contour in some region or regions and have a clearance with respect thereto in some region or regions. The displacement space can be delimited by the elastomer cap and the mating contour. It is thereby possible to set a softer or harder torsion characteristic and to influence the progression.

It is conceivable that a plurality of decoupling pins is fixed on at least one end face of the stator element and/or to a circumferential surface of the stator element and/or to the housing. The decoupling pins on one axial side of the stator element can form a pin arrangement. The decoupling function can advantageously be distributed between a plurality of decoupling pins.

It is conceivable that a different number of decoupling pins is arranged on the two axial sides of the stator element. The unequal number leads to splitting between an axial side which serves principally for high torque transmission and an axial side which principally has a support function.

It is conceivable that the decoupling pins in their pin arrangement lie on an imaginary circle or are at nonuniform radial distances from the central longitudinal axis in the circumferential direction and/or are spaced apart uniformly or nonuniformly in the circumferential direction. The positioning of the decoupling pins on the circle serves for uniform decoupling, and nonuniform positioning is advantageous to satisfy installation space requirements.

Unless stated otherwise, directions (axial direction, longitudinal direction, radial direction, circumferential direction, translational/rotational directions etc.) described herein fundamentally relate to the stator element or the central longitudinal axis. Bearing contact described herein can be loose bearing contact, unless stated otherwise.

The description of a (single) elastomeric support element can be applied to other elastomeric support elements. For reasons of greater readability, one/the elastomeric support element is generally described, but the disclosure also includes at least one/the elastomeric support element where there is no limitation to a single support element.

Further features, details and advantages of the invention will be apparent from the wording of the claims and also from the description below of exemplary embodiments with reference to the drawings, in which:

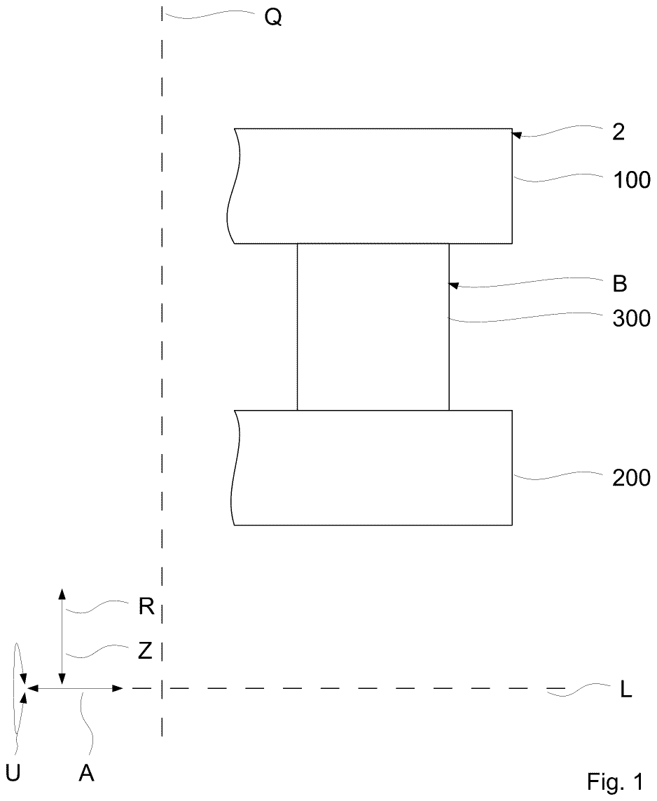

FIG. 1 shows a schematic diagram of an electric motor assembly,

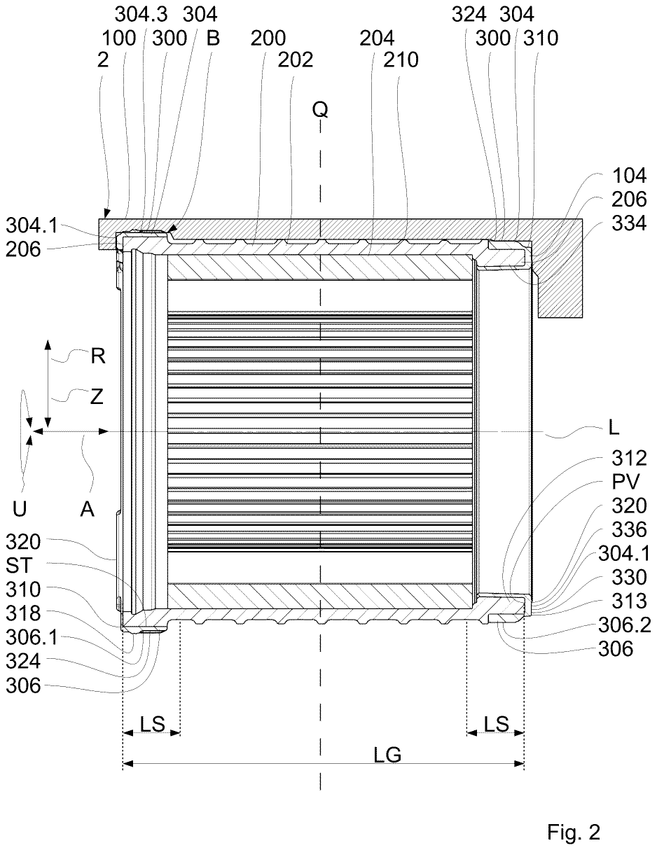

FIG. 2 shows a longitudinal section through an electric motor assembly having a decoupling ring,

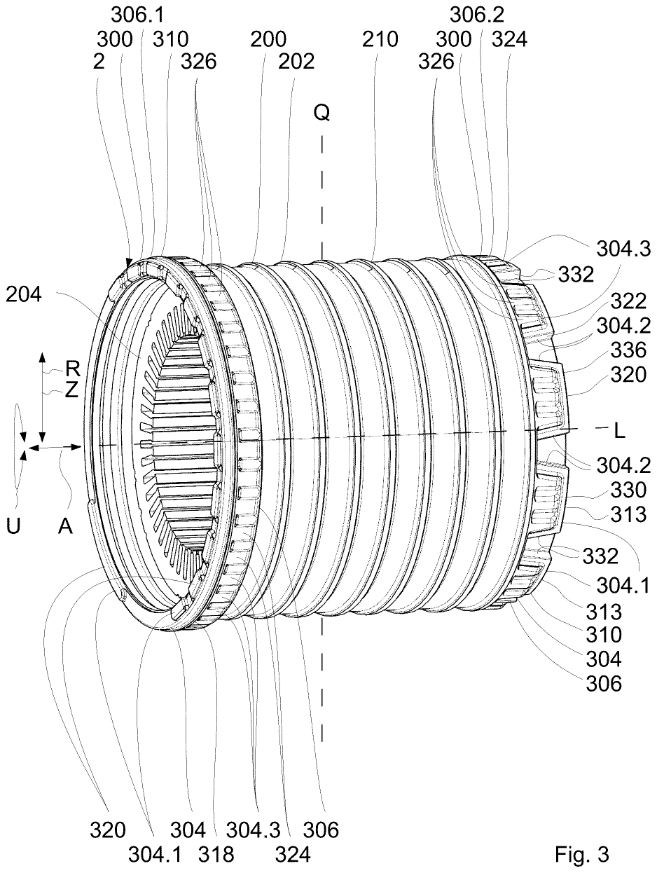

FIG. 3 shows a perspective view of an electric motor assembly having a decoupling ring,

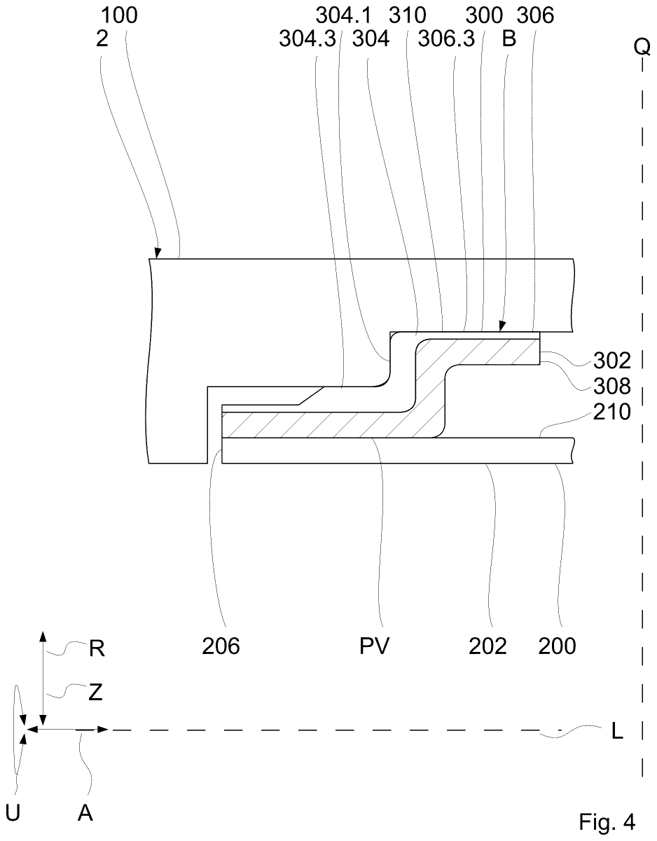

FIG. 4 shows a detail view of an electric motor assembly having a decoupling ring,

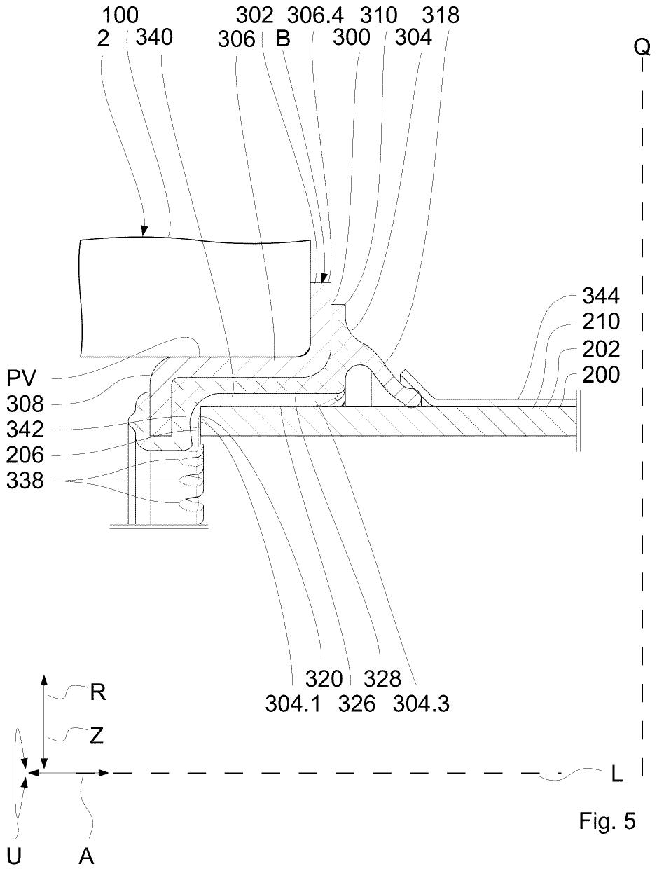

FIG. 5 shows another detail view of an electric motor assembly having a decoupling ring,

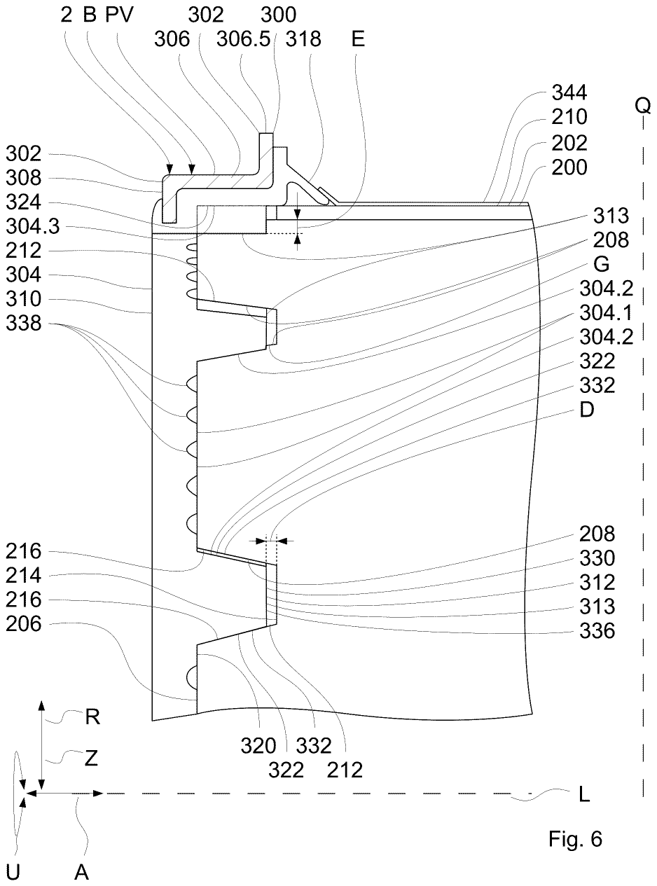

FIG. 6 shows another detail view of an electric motor assembly having a decoupling ring,

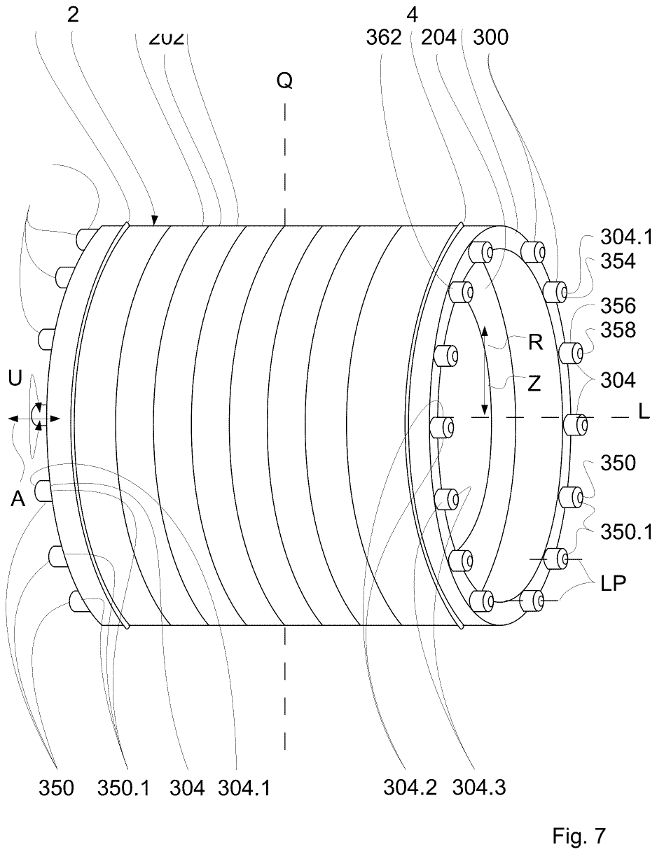

FIG. 7 shows a perspective view of an electric motor assembly having decoupling pins,

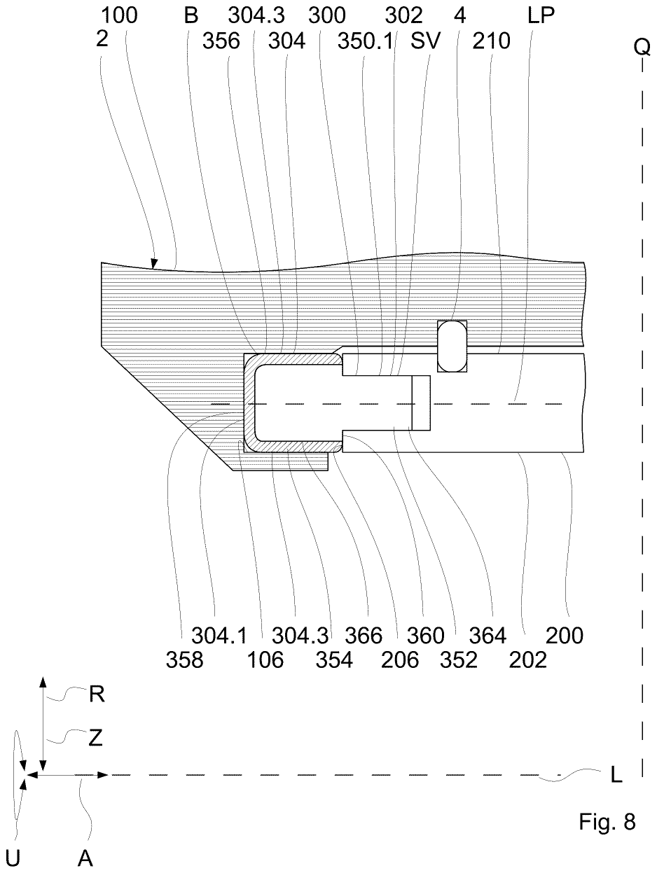

FIG. 8 shows a detail view of an electric motor assembly having decoupling pins, and

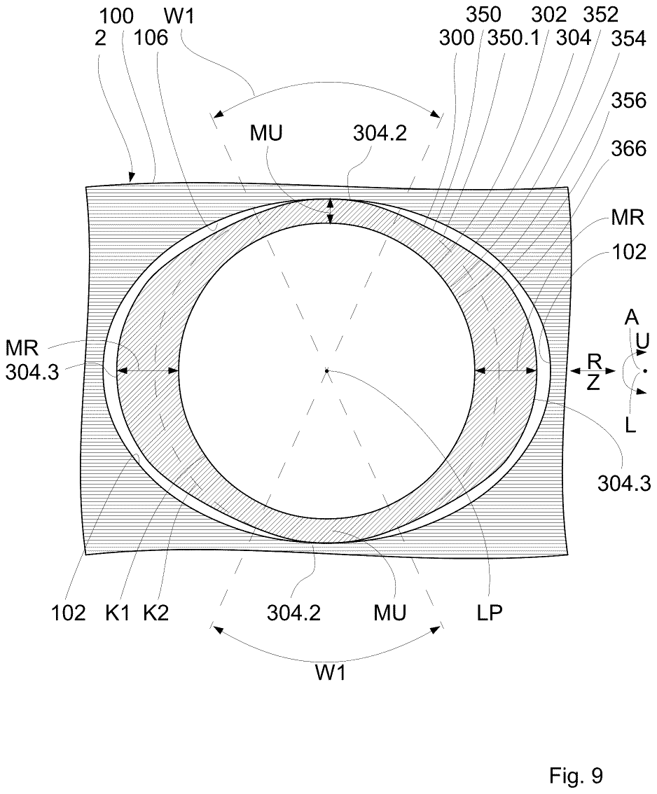

FIG. 9 shows a detail view of an electric motor assembly having decoupling pins.

In the figures, identical or mutually corresponding elements are each labelled with the same reference signs and therefore are not described again if not appropriate. In order to avoid repetition, features that have already been described will not be described again, and such features are applicable to all elements with the same or mutually corresponding reference signs unless this is explicitly ruled out. The disclosures in the description as a whole are applicable analogously to identical parts with the same reference signs or the same component designations. It is also the case that the statements of position chosen in the description, for example at the top, at the bottom, at the side, etc., relate to the figure illustrated and presently being described and, in the case of a change in position, should be applied analogously to the new position. Furthermore, it is also possible for individual features or combinations of features from the different exemplary embodiments shown and described to constitute independent inventive solutions or solutions according to the invention.

FIG. 1 shows a fixing B and a schematic elastomeric decoupling of a stator element 200 from a housing 100 of an electric motor assembly 2 by means of an elastomeric support 300. The fixing B is the only fixing between the housing 100 and the stator element 200. A radial direction R, which corresponds as it were also to a centrifugal direction Z, extends perpendicularly to a central longitudinal axis L. An axial direction A extends along the central longitudinal axis L. A circumferential direction U extends around the longitudinal axis A, and a transverse center plane Q is arranged in such a way that its normal vector lies on the central longitudinal axis L. These direction indications all refer in general to the electric motor assembly 2. Separate reference is made to direction indications that differ therefrom, in particular within the description of the decoupling pin 350. The subsequent FIGS. 2 to 9 build on FIG. 1, and therefore features that have already been described are not described again below. Moreover, in the description of FIGS. 2 to 9, repeated description of features that have already been designated is dispensed with in order to avoid repetitions. Elements of the housing 100 have a reference sign in the 100s. Elements of the stator element 200 have a reference sign in the 200s. Elements of the support 300 have a reference sign in the 300s, with reference signs 306 to 344 relating specifically to the decoupling ring 306, and reference signs 350 to 366 referring to the decoupling pin 350.

The elastomeric decoupling involves at least one elastomeric support 300. The stator element 200 is supported axially at both ends by means of elastomeric supports 300. All of the elastomeric supports 300 are arranged in such a way as to elastomerically decouple at one end of the stator element 200 and/or are arranged in such a way that they are each located in an end-face region of the length LS of the stator element 200, which corresponds, for example, to at most 20% of the total axial length LG of the stator element 200.

FIGS. 2 to 6 show an elastic support 300 in the form of a decoupling ring 306 in various illustrative embodiments, the reference signs of which are 306.1, 306.2, 306.3, 306.4 and 306.5. The fixing B shown there can comprise two decoupling rings 306 of different design in accordance with the disclosure. The fixing B shown there can comprise not only the at least one decoupling ring 306 but also at least one decoupling pin 350, which is shown in various illustrative embodiments in FIGS. 7 to 9 and is described more generally in the description of the invention.

FIG. 2 shows a longitudinal section through an electric motor rotor assembly 2, which is shown in perspective in FIG. 3. The housing 100 has been omitted in FIG. 3. The two FIGS. 2 and 3 are described together. The electric motor rotor assembly 2 comprises a central longitudinal axis L, which passes through the electric motor rotor assembly 2. The housing 100 is depicted as a motor housing. The stator element 200 is depicted as a sleeve-type stator carrier 202, which carries a stator 204 arranged on the inner circumference. The stator element 200 has a stator carrier end face 206 axially at both ends and has a stator carrier circumferential surface 210, which is an outer circumferential surface. In some embodiments, the stator element 200 comprises a mating radial contact surface 208. The stator element 200 is supported in a fully elastomeric way on the housing 100 via a fixing B. In the present case, the fixing B comprises two elastomeric supports 300, each in the form of a decoupling ring 306 embodied as a decoupling ring 306.1, 306.2.

The elastomeric support 300 is described below in the form of a decoupling ring 306.1. It comprises a one-piece elastomer element 304. It bears on the housing 100 in the circumferential direction U and in the axial direction A and in the radial direction R. The elastomeric support 300 is without a carrier element. Since no carrier element for the support 300 is provided, the elastomer element 304 is fixed directly to the stator element 200. The elastomeric support 300 comprises at least one elastomeric axial support 304.1 and at least one elastomeric radial support 304.3. The elastomeric support 300 in the form of decoupling ring 306.1 forms a material joint ST for self-fixing on the stator element 200. The elastomer element 304 is an elastomer ring 310. The decoupling ring 306.1 and the elastomer ring 310 are continuous in the circumferential direction U. The decoupling ring 306.1 is formed exclusively by the elastomer ring 310.

In the case of decoupling ring 306.1, the axial support 304.1 is formed by an elastomeric contact end face 320 of the elastomer ring 310. The contact end face 320 bears on the housing 100. In the case of decoupling ring 306.1, the radial support 304.3 is formed by an elastomeric circumferential contact surface 324 of the elastomer ring 310. The contact end face 320 bears on the housing 100. In the case of decoupling ring 306.1, the elastomer ring 310 forms bearing pads 326 that are adjacent in the circumferential direction U. The bearing pads 326 correspond to the radial supports 304.3. The electric motor assembly 2 comprises an elastomeric ring seal 318, which is of continuous design in the circumferential direction U. The ring seal 318 forms a seal between the housing 100 and the stator element 200. The ring seal 318 is subjected to pressure in the radial direction R and is formed by the elastomer element 304.

The elastomeric support 300 is described below in the form of a decoupling ring 306.2. It comprises a one-piece elastomer element 304. The elastomer element 304 bears on the housing 100 in the circumferential direction U and in the axial direction A and in the radial direction R. The elastomeric support 300 is likewise without a carrier element. Since no carrier element for the support 300 is provided, the elastomer element 304 is fixed directly to the stator element 200. The elastomeric support 300 comprises at least one elastomeric axial support 304.1 and at least one elastomeric torsional support 304.2 and at least one elastomeric radial support 304.3. The elastomeric support 300 in the form of decoupling ring 306.2 forms a press-fit joint P for self-fixing on the stator element 200. The elastomer element 304 is an elastomer ring 310. The decoupling ring 306.2 and the elastomer ring 310 are continuous in the circumferential direction U. The decoupling ring 306.2 is formed exclusively by the elastomer ring 310.

The decoupling ring 306.2 forms an elastomeric tooth system 312 with teeth 313, which engages in a form-fitting manner in a corresponding mating contour 104 on the housing 100. The teeth 313 are trapezoidal when viewed in the radial direction R and the mating contour 104 is likewise trapezoidal when viewed in the radial direction R. The mating contour 104 is formed by the housing 100. The tooth system 312 or the teeth 313 thereof bear in the circumferential direction U and in the axial direction A and in the radial direction R. Each tooth 313 has a tooth head 330 with a head surface 336 and two tooth flanks 332. The trapezoidal shape of the teeth 313 and of the mating contour 104 tapers in the direction of the transverse center plane Q. The tooth flanks 332 bear on the mating contour 104. The teeth 313 each comprise a tooth core 334, which is formed by the stator element 200. The tooth core 334 is formed by virtue of the fact that the stator element 200 projects by means of a protrusion into the elastomer ring 310.

In the case of decoupling ring 306.2, the axial support 304.1 is formed by an elastomeric contact end face 320 of the elastomer ring 310. The contact end face 320 bears on the housing 100, e.g. on the mating contour 104. The contact end face 320 promotes axial stiffness. The contact end face 320 is identical with the head surface 336. In the case of decoupling ring 306.2, the torsional support 304.2 is formed by elastomeric radial contact surfaces 322 of the elastomer ring 310. The radial contact surfaces 322 bear on the housing 100, e.g. on the mating contour 104, in the circumferential direction U. The radial contact surfaces 322 are formed by the tooth flanks 332. In the case of decoupling ring 306.2, the radial support 304.3 is formed by an elastomeric circumferential contact surface 324 of the elastomer ring 310. The circumferential contact surface 324 bears on the housing 100, e.g. on the mating contour 104. The circumferential contact surface 324 is an outer circumferential surface. In the case of decoupling ring 306.2, the elastomer ring 310 forms bearing pads 326 that are adjacent in the circumferential direction U. The bearing pads 326 correspond to the radial supports 304.3.

FIG. 4 shows a longitudinal section through a detail view of an electric motor rotor assembly 2. The elastomeric support 300 is described below in the form of a decoupling ring 306.3. The decoupling ring 306.3 comprises a one-piece elastomer element 304. It bears on the housing 100 in the radial direction R and in the axial direction A. The elastomeric support 300 furthermore comprises a separate carrier element 302. The single carrier element 302 carries the single elastomer element 304. The elastomeric support 300 comprises at least one elastomeric axial support 304.1 and at least one elastomeric radial support 304.3. The elastomeric support 300 in the form of decoupling ring 306.3 forms a press-fit joint P for self-fixing on the stator element 200. The elastomeric support 300 in the form of decoupling ring 306.3 comprises a carrier ring 308 and an elastomer ring 310. The carrier ring 308 is the carrier element 302. The elastomer ring 310 is the elastomer element 304. The decoupling ring 306.3 and the carrier ring 308 and the elastomer ring 310 are continuous in the circumferential direction U. The carrier ring 308 is a separate part from the housing 100 and the stator element 200. The carrier ring 308 has a Z profile in longitudinal section, wherein the legs of the profile enclose right angles. The elastomer ring 310 is arranged on at least one leg. In the case of the decoupling ring 306.3, the axial support 304.1 and the radial support 304.3 bear on the housing 100.

FIG. 5 shows a longitudinal section through a detail of an electric motor rotor assembly 2. The elastomeric support 300 is described below in the form of a decoupling ring 306.4. It comprises a one-piece elastomer element 304. It bears on the stator element 200 in the axial direction A and/or in the radial direction R. The elastomeric support 300 furthermore comprises a separate carrier element 302. The single carrier element 302 carries the single elastomer element 304. The elastomeric support 300 comprises at least one elastomeric axial support 304.1 and at least one elastomeric radial support 304.3. The elastomeric support 300 in the form of decoupling ring 306.4 forms a press-fit joint P for self-fixing on the housing 100. The decoupling ring 306.4 comprises a carrier ring 308 and an elastomer ring 310. The carrier ring 308 is the carrier element 302. The elastomer ring 310 is the elastomer element 304. The elastomer ring 310 is the elastomer element 304. The decoupling ring 306.4 and the carrier ring 308 and the elastomer ring 310 are continuous in the circumferential direction U. The carrier ring 308 has a Z profile in longitudinal section, wherein the legs of the profile enclose right angles. The elastomer ring 310 is arranged on at least one leg. In the case of the decoupling ring 306.4, the axial support 304.1 and the radial support 304.3 bear on the stator element 200.

In the case of decoupling ring 306.4, the axial support 304.1 is formed by an elastomeric contact end face 320 of the elastomer ring 310. The contact end face 320 bears on the stator carrier end face 206. The elastomeric contact end face 320 forms contact end-face recesses 338, in the present case of arcuate configuration. The contact end-face recesses 338 have an axial clearance with respect to the bearing surface of the stator element 200, in the present case with respect to the stator carrier end face 206. The radial support 304.3 is formed by the elastomeric circumferential contact surface 324 of the elastomer ring 310, in the present case by the inner circumferential surface thereof.

The elastomer ring 310 of the decoupling ring 306.4 alternately forms bearing pads 326 and passage portions 328 in the circumferential direction U. The bearing pads 326 form the axial supports 304.1 and the radial supports 304.3. The bearing pads 326 bear on the stator element 200. In the present case, the axial support 304.1 bears on the stator carrier end face 206, and the radial support 304.3 bears on the circumferential surface of the stator element 200. Each bearing pad 326 can be formed by an axial support 304.1 and a radial support 304.3.

The passage portions 328 form a clearance with respect to the stator element 200, in the present case with the outer circumferential surface and the stator carrier end face 206. The passage portions 328 are axial passages and radial passages. Each passage portion 328 is formed by an axial passage 340 and a radial passage 342. The passage portions 328 are delimited by the elastomer body 310 and the stator element 200.

The decoupling ring 306.4 forms the ring seal 318 integrally with the elastomer ring 310. The ring seal 318 extends in the direction of the transverse center plane Q. The ring seal 318 is squeezed in the radial direction R by a sleeve 344.

FIG. 6 shows a longitudinal section through a detail of an electric motor rotor assembly 2. The elastomeric support 300 is described below as a decoupling ring 306.5. It resembles the elastomer ring 306.2 but the teeth 313 now no longer bear elastomerically on the housing 100 but on the stator element 200. The elastomer ring 306.5 comprises a one-piece elastomer element 304. It bears on the stator element 200 in the circumferential direction U and in the axial direction A and in the radial direction R. The elastomeric support 300 furthermore comprises a separate carrier element 302. The single carrier element 302 carries the single elastomer element 304. The elastomeric support 300 comprises at least one elastomeric axial support 304.1 and at least one elastomeric torsional support 304.2 and at least one elastomeric radial support 304.3 (shown in dashed lines for reasons of illustration since it is concealed by the tooth). The elastomeric support 300 in the form of elastomer ring 306.2 forms a press-fit joint P for self-fixing on the housing 100 (not illustrated).

The decoupling ring 306.5 forms the ring seal 318 integrally with the elastomer ring 310. The ring seal 318 extends in the direction of the transverse center plane Q. The ring seal 318 is squeezed in the radial direction R by a sleeve 344.

The decoupling ring 306.5 comprises a carrier ring 308 and an elastomer ring 310. The carrier ring 308 is the carrier element 302. The elastomer ring 310 is the elastomer element 304. The elastomer ring 310 is the elastomer element 304. The decoupling ring 306.5 and the carrier ring 308 and the elastomer ring 310 are continuous in the circumferential direction U. The carrier ring 308 has a Z profile in longitudinal section, wherein the legs of the profile enclose right angles. The elastomer ring 310 is arranged on at least one leg. In the case of the decoupling ring 306.5, the axial support 304.1, the torsional support 304.2 and the radial support 304.3 bear on the stator element 200.

The decoupling ring 306.5 forms an elastomeric tooth system 312 with teeth 313, which engages in a form-fitting manner in a corresponding mating contour 212. The teeth 313 are trapezoidal when viewed in the radial direction R and the mating contour 212 is likewise trapezoidal when viewed in the radial direction R. The mating contour 212 is formed by the stator element 200, in the present case by end-face recesses. The mating contour 212 comprises an axial surface 214 and two radial surfaces 216. The tooth system 312 and the teeth 313 thereof bear on the mating contour 212 in the circumferential direction U. Each tooth 313 has a tooth head 330 and two tooth flanks 332.

The teeth 313 each have a free head surface 336 on a tooth head 330. The head surface 336 delimits a gap G. There is an axial clearance between the head surface 336 and the mating contour 212 or the axial surface 214—an axial spacing D is formed. The trapezoidal shape of the teeth 313 and of the mating contour tapers in the direction of the transverse center plane Q. The tooth flanks 332 bear on the mating contour 212 or radial surfaces 216. The teeth 313 each project in the radial direction R into the interior of the stator element 200, preferably by an inward projection distance E of from 1 mm to 10 mm.

In the case of decoupling ring 306.5, the axial support 304.1 is formed by an elastomeric contact end face 320 of the elastomer ring 310. The contact end face 320 bears on the stator carrier end face 206. The elastomeric contact end face 320 forms contact end-face recesses 338, which in the present case are of arcuate configuration. The contact end-face recesses 338 have an axial clearance with respect to the bearing surface of the stator element 200, in the present case with respect to the stator carrier end face 206. The torsional supports 304.2 are formed by elastomeric radial contact surfaces 322 of the elastomer ring 310. The radial contact surfaces 322 bear on the stator element 200 in the circumferential direction U and are formed by the tooth flanks 332. The radial support 304.3 is formed by the elastomeric circumferential contact surface 324 of the elastomer ring 310, in the present case by the inner circumferential surface thereof.

The decoupling ring 306.5 forms the ring seal 318 integrally with the elastomer ring 310. The ring seal 318 extends in the direction of the transverse center plane Q. The ring seal 318 is squeezed in the radial direction R by the sleeve 344.

FIG. 7 shows a perspective view of an electric motor rotor assembly 2, which is shown in detail in FIG. 8. The housing 100 has been omitted in FIG. 7. The two FIGS. 7 and 8 are described together. The electric motor rotor assembly 2 comprises a central longitudinal axis L, which passes through the electric motor rotor assembly 2. The housing 100 is depicted as a motor housing. The stator element 200 is depicted as a sleeve-type stator carrier 202, which carries a stator 204 arranged on the inner circumference. The stator element 200 has a stator carrier end face 206 axially at both ends and has a stator carrier circumferential surface 210, which is an outer circumferential surface. The stator element 200 is supported in a fully elastomeric way on the housing 100 via a fixing B. In the present case, the fixing B comprises a plurality of elastomeric supports 300, each in the form of a decoupling pin 350.1.

One of the elastomeric supports 300 in the form of a decoupling pin 350.1 is described by way of example below. It comprises a one-piece elastomer element 304. The elastomeric support 300 bears on the housing 100 in the circumferential direction U and in the axial direction A and in the radial direction R. The elastomeric support 300 furthermore comprises a separate carrier element 302. The single carrier element 302 carries the single elastomer element 304. The elastomeric support 300 comprises at least one elastomeric axial support 304.1 and at least one elastomeric torsional support 304.2 and at least one elastomeric radial support 304.3.

The elastomeric support 300 in the form of decoupling pin 350.1 forms a screwed joint SV as an illustrative joint for self-fixing on the stator element 200.

The electric motor rotor assembly 2 comprises a ring seal 4 at each of the two axial ends, and this seal is arranged continuously in the circumferential direction U on the stator carrier circumferential surface 210. Each ring seal 4 forms a seal between the housing 100 and the stator element 200. The ring seal 4 is subjected to pressure or squeezed in the radial direction R. The ring seal 4 is a separate part from the elastomer element 304.

The elastomeric support in the form of decoupling pin 350.1 comprises a carrier pin 352 and an elastomer cap 354. The carrier pin 352 is the carrier element 302, and the elastomer cap 354 is the elastomer element 304. The carrier pin 352 is a separate part from the housing 100 and the stator element 200. Each decoupling pin 350.1 has a pin longitudinal axis LP. It extends through the decoupling pin 350.1 in the longitudinal direction. In the present case, the pin longitudinal axis LP runs parallel to the central longitudinal axis L.

The carrier pin 352 carries the elastomer cap 354. The elastomer cap 354 can be fixed on the carrier pin 352 by material bonding (vulcanized on or by means of an adhesion promoter) or press-fitted thereon. The carrier pin 352 forms a backing structure for the elastomer cap 354 and is in one piece. The carrier pin 352 forms a fixing region 364 and a carrier region 366. The fixing region 364 fixes the carrier pin 352 on the stator element 200. In the present case, the fixing region forms a thread. The carrier region 366 carries the elastomer cap 354. The carrier region 366 forms a fixing stop 360. The carrier region 366 has a larger diameter than the fixing region 364.

The elastomer cap 354 forms a cylindrical portion 356 and an end-face portion 358. The elastomer cap 354 furthermore engages in a form-fitting manner and in the axial direction A in a corresponding mating contour 106 of the housing 100. The cylindrical portion 356 is a hollow-cylindrical portion, and is backed by the carrier region 366. The cylindrical portion 356 is continuous in the circumferential direction U (in relation to the pin longitudinal axis LP). The elastomer cap 354 bears fully on the mating contour 106 at the circumference. The end-face portion 358 is disk-shaped, and is backed by the carrier region 366. The elastomer cap 354 bears axially on the mating contour 106. The decoupling pin 350.1, the carrier pin 352, the carrier region 366 and the elastomer cap 354 are bodies of revolution with respect to their own pin longitudinal axis LP. The mating contour 106 is a solid of revolution with respect to the corresponding pin longitudinal axis LP.

As is evident, a plurality of decoupling pins 350.1 is fixed on each end of the stator element 200. The decoupling pins 350.1 on one axial side of the stator element 200 form a pin arrangement 362. The decoupling pins 350.1 in their pin arrangement 362 can lie on an imaginary circle or can be at nonuniform radial distances from the central longitudinal axis L in the circumferential direction U.

To avoid repetitions, only the differences of FIG. 9 from FIGS. 7 and 8 are described below. FIG. 9 shows the elastomeric support 300 in the form of decoupling pin 350.2 in cross section. The elastomer element 304 bears on the housing 100 in the circumferential direction U and in the axial direction A but not in the radial direction R. The elastomer cap 354 therefore bears only partially on the mating contour 106.

The elastomer cap 354 of the decoupling pin 350.2 differs essentially in having a different cross section.

The elastomer cap 354 has a 2-fold rotational symmetry in relation to its own pin longitudinal axis LP (n=2). The elastomer cap 354 has two regions of a first material thickness, here referred to as a material thickness in the radial direction MR, which lie diametrically opposite one another in relation to the pin longitudinal axis LP, and two further regions of a second material thickness, here referred to as a material thickness in the circumferential direction MU, which lie diametrically opposite one another in relation to the pin longitudinal axis LP. The first material thickness is greater than the second material thickness. As a result, the elastomer pad of the decoupling pin 350.2 is thicker in one spatial direction than in another spatial direction.

The elastomer cap 354 can be oval in cross section and/or can have a constant material thickness in a first angular window W1, which lies in the circumferential direction U. In the present case, the angular windows W1 have the corresponding pin longitudinal axis LP as a center.

The outer circumferential surface of the carrier pin 352 and the carrier region 366 thereof lie on an imaginary first circle K1. The outer circumferential surface of the elastomer cap 354, when viewed overall, lies on an imaginary second circle K2 in some section or sections, but lies fully on said circle within the first angular window W1. The two imaginary circles K1, K2 are concentric circles. This produces a constant material thickness of the elastomer cap 354 in this region. The first angular windows W1 lie in the circumferential direction U and diametrically opposite one another in relation to the pin longitudinal axis LP.

The mating contour 106 has a 2-fold rotational symmetry in relation to the corresponding pin longitudinal axis LP (n=2). The rotational symmetry of the mating contour 106 is set in such a way that different stiffnesses are obtained in different spatial directions. The mating contour 106 is oval in cross section. The long transverse extent of the oval mating contour 106 extends in the radial direction R, and the short transverse extent runs in the circumferential direction U, in relation to the central longitudinal axis L.

The mating contour 106, together with the elastomer cap 354, delimits two displacement spaces 102. Elastomer from the elastomer cap 354 can be displaced into these when acted upon by a load. The two displacement spaces 102 lie diametrically opposite one another along the radial direction R in relation to the pin longitudinal axis LP, thereby creating displacement spaces 102 in the centrifugal direction Z. The elastomer cap 354 thus bears on two regions located diametrically opposite in the circumferential direction U in relation to the pin longitudinal axis LP and delimits two displacement spaces 102 in the radial direction R. The elastomer cap 354 therefore bears on the mating contour 106 in some regions and has a clearance with respect thereto in some regions.

FIGS. 7 to 9 show an elastic support 300 in the form of a decoupling pin 350 in various illustrative embodiments. The fixing B shown there can comprise not only the at least one decoupling pin 350.1, 350.2 but also at least one decoupling ring 306.1, 306.2, 306.3, 306.4, 306.5, which is shown in various illustrative embodiments in FIGS. 2 to 6 and is described more generally in the description of the invention.

The invention is not restricted to any of the embodiments described above and instead can be modified in various ways. All the features and advantages that are apparent from the claims, the description and the drawing, including structural details, spatial arrangements and method steps, may be essential to the invention both individually and in a very wide variety of combinations. The scope of the invention encompasses all combinations of at least two of the features disclosed in the description, the claims and/or the figures. To avoid repetitions, features disclosed in relation to a device are also considered to be disclosed, and claimable, in relation to a method. It is likewise the case that features disclosed in relation to a method are considered to be disclosed, and claimable, in relation to a device.

List of reference signs

| | |
|---|---|
| 2 | electric motor assembly |
| 4 | ring seal |
| 100 | housing |
| 102 | displacement space |
| 104 | mating contour |
| 106 | mating contour |
| 200 | stator element |
| 202 | stator carrier |
| 204 | stator |
| 206 | stator carrier end face |
| 208 | mating radial contact surface |
| 210 | stator carrier circumferential surface |
| 212 | mating contour |
| 214 | axial surface |
| 216 | radial surface |
| 300 | support |
| 302 | carrier element |
| 304 | elastomer element |
| 304.1 | axial support |
| 304.2 | torsional support |
| 304.3 | radial support |
| 306 | decoupling ring |
| 306.1 | decoupling ring |
| 306.2 | decoupling ring |
| 306.3 | decoupling ring |
| 306.4 | decoupling ring |
| 306.5 | decoupling ring |
| 308 | carrier ring |
| 310 | elastomer ring |
| 312 | tooth system |
| 313 | tooth |
| 318 | ring seal |
| 320 | contact end face |
| 322 | radial contact surface |
| 324 | circumferential contact surface |
| 326 | bearing pad |
| 328 | passage portion |
| 330 | tooth head |
| 332 | tooth flank |
| 334 | tooth core |
| 336 | head surface |
| 338 | contact end-face recess |
| 340 | axial passage |
| 342 | radial passage |
| 344 | sleeve |
| 350 | decoupling pin |
| 350.1 | decoupling pin |
| 350.2 | decoupling pin |
| 352 | carrier pin |
| 354 | elastomer cap |
| 356 | cylindrical portion |
| 358 | end-face portion |
| 360 | fixing stop |
| 362 | pin arrangement |
| 364 | fixing region |
| 366 | carrier region |
| A | axial direction |
| B | fixing |
| D | axial spacing |
| E | inward projection distance |
| G | gap |
| K1 | first circle |
| K2 | second circle |
| L | central longitudinal axis |
| LG | total length |
| LP | pin longitudinal axis |
| LS | end-face region of the length |
| MU | material thickness |
| MR | material thickness |
| PV | press-fit joint |
| Q | transverse center plane |
| R | radial direction |
| ST | material joint |
| SV | screwed joint |
| U | circumferential direction |
| W1 | angular window |
| Z | centrifugal direction |

1. An electric motor assembly (2), comprising
a central longitudinal axis (L), which passes through the electric motor rotor assembly (2),
a housing (100),
a stator element (200), which is fixed on the housing (100) by means of a fixing (B),
wherein the fixing (B) comprises at least one elastomeric support (300) for elastomeric decoupling.

2. The electric motor assembly (2) as claimed in claim 1, wherein the elastomeric support (300) comprises an elastomer element (304), the elastomer element (304) preferably is in contact in the circumferential direction (U) and/or in the axial direction (A) and/or in the radial direction (R), the elastomeric support (300) further comprising a carrier element (302).

3. The electric motor assembly (2) as claimed in claim 1, wherein the elastomeric support (300) forms a press-fit joint (PV) or a material joint (ST) or a screwed joint (SV) for self-fixing.

4. The electric motor assembly (2) as claimed in claim 1, which comprises an elastomeric ring seal (318), the ring seal (318) preferably being continuous in the circumferential direction (U).

5. The electric motor assembly (2) as claimed in claim 1, wherein the elastomeric support (300) is a decoupling ring (306), preferably comprising a carrier ring (308) and an elastomer ring (310).

6. The electric motor assembly (2) as claimed in claim 5, wherein the decoupling ring (306) forms an elastomeric tooth system (312) with teeth (313), which engages in a form-fitting manner in a corresponding mating contour (104), the teeth (313) preferably being trapezoidal when viewed in the radial direction (R) and/or the mating contour (104) being trapezoidal when viewed in the radial direction (R).

7. The electric motor assembly (2) as claimed in claim 1, wherein the elastomeric support (300) is a decoupling pin (350), preferably comprising a carrier pin (352) and an elastomer cap (354).

8. The electric motor assembly (2) as claimed in claim 7, wherein the elastomer cap (354) forms a cylindrical portion (356) and/or an end-face portion (358) and engages in a corresponding mating contour (106).

9. The electric motor assembly (2) as claimed in claim 7, wherein the decoupling pin (350) and/or the carrier pin (352) and/or the carrier region and/or the fixing region and/or the elastomer cap (354) are/is rotationally symmetrical with respect to their/its own pin longitudinal axis (LP) or are/is a solid of revolution.

10. The electric motor assembly (2) as claimed in claim 7, wherein the elastomer cap (354) is in contact in the circumferential direction (U) and delimits at least one displacement space (102) in the radial direction (R) or vice versa.
